(19) United States
(12) Patent Application Publication
(10) Pub. No.: US 2011/0109115 A1
(43) Pub. Date: May 12, 2011

(54) TERMINAL STRUCTURE AND GLASS PLATE WITH TERMINAL FOR VEHICLES

(76) Inventors: Kazuo Yamada, Tokyo (JP); Hideo Yoshizawa, Tokyo (JP); Ichiro Okajima, Tokyo (JP)

(21) Appl. No.: 12/737,353

(22) PCT Filed: Jun. 30, 2009
(86) PCT No.: PCT/JP2009/061932

§ 371 Date: Jan. 4, 2011

(30) Foreign Application Priority Data
Jul. 8, 2008 (JP) 2008-177842

(51) Int. Cl. H05B 3/84; B60J 1/00; H05B 1/00

(52) U.S. Cl. 296/84.1; 219/201

(57) ABSTRACT

Disclosed is a terminal structure which has a high degree of freedom in selecting the mounting position. A terminal part (18) is affixed to a glass plate (11) with an adhesive (27). A conductive member (19) extends from the terminal part (18) too an object of power supply. The conductive member (19) is flexible.

### TECHNICAL FIELD

The present invention relates to a terminal structure and, more particularly, to a terminal structure suitable for use on a vehicle glass sheet.

### BACKGROUND ART

An example of a vehicle glass sheet equipped with a terminal will now be described. A heater is installed in the vehicle glass sheet, and power is supplied to the heater from an external power source. The power supply system may entail a harness, which extends from the external power source, connected directly to the heater, but out of consideration for convenience in the structure and assembly, the power supply system is preferably connected by a terminal in a manner that allows it to be disconnected.

There are various known examples of terminal structures for this purpose (for example, see Patent Documents 1 and 2).

FIG. 6 hereof shows the terminal structure disclosed in Patent Document 1. As shown in the Figure, a terminal 100 has leg parts 105, 106 bonded via solder 103, 104 to the top of a conductive film 101 formed on the top surface of a glass sheet 102, and a support part 107 provided at a distal end of the leg part 106.

From the distal end of a bonded part 108 which is bonded with the support part 107, a lead wire 109 extends toward the power source or another device mounted, e.g., inside the vehicle.

In the structure of the terminal 100, the bonding surface area can be adequately increased by soldering using the two leg parts 105, 106. The strength of the terminal 100 against loads applied in the tensile direction is increased by increasing the bonding surface area.

FIG. 7 shows a T-shaped terminal disclosed in Patent Document 2. Referring to FIG. 7, the T-shaped terminal 110 has a female terminal part 111 mounted at the distal end, and the T-shaped terminal 110 is bonded to the glass via an adhesive 112 and solder 113. With this T-shaped terminal 110, the amount by which the solder 113 is used can be reduced by using the adhesive 112 together with the solder 113.

When these terminals are mounted on a glass sheet, the positions at which the terminals are mounted are primarily determined to an extent from the mounted position of the heater and the mounted position of the lead wire extending from the power source. Therefore, there is little degree of freedom in the position where the terminal is mounted.

In view whereof, a demand has arisen for a terminal structure having a high degree of freedom in its mounted position.

### PRIOR ART DOCUMENTS

### Patent Documents

Patent Document 1: Japanese Patent No. 3957302
Patent Document 2: Japanese Patent Application Laid-Open Publication No. 2003-521093

### DISCLOSURE OF THE INVENTION

### Problem(s) Sought to be Solved by the Invention

It is therefore an object of the present invention to provide a terminal structure that provides a high degree of freedom in its mounted position.

According to an aspect of the present invention, there is provided a terminal structure, which comprises a terminal part capable of being affixed to a glass sheet by an adhesive, and a conductive member extending from the terminal part to an object of power supply and having flexibility.

In the present invention, the highly flexible conductive member is made to extend from the terminal part to the object of power supply. The terminal and the object of power supply are connected by extending the conductive member. Since the conductive member is flexible, the conductive member can be mounted without interfering with the other components and the like. Additionally, the length of the conductive member can be any desired length. Specifically, the terminal part can be freely mounted even in a position that is distanced from the object of power supply. The terminal structure can be referred to as one having a high degree of freedom in its mounted position.

Preferably, the conductive member has a distal end part, and the distal end part is a sheet-shaped part. Since the sheet-shaped part covers the connecting portion between the object of power supply and the conductive member, the connecting portion is not outwardly visible. The outward appearance of the terminal structure is improved by keeping the connecting portion from being outwardly visible.

Preferably, the conductive member has a distal end part, and the distal end part is bonded to the object of power supply by a solder or a conductive adhesive. The solder or the conductive adhesive has excellent conductivity. Because of the excellent conductivity, satisfactory conductivity can be maintained in the devices connected to the object of power supply and the terminal.

According to another aspect of the present invention, there is provided a glass sheet with a terminal for a vehicle, comprising a glass sheet for a vehicle, a terminal part affixed to the glass sheet by an adhesive, and a conductive member extending from the terminal part to an object of power supply and having flexibility.

In the invention according to this other aspect, the connection is achieved by extending the highly flexible conductive member from the terminal part to the object of power supply. The highly flexible conductive member is extended to the object of power supply. Since the conductive member is flexible, the conductive member can be mounted without interfering with the other components and the like. Additionally, the length of the conductive member can be any desired length. Specifically, the terminal part can be freely mounted even in a position that is distanced from the object of power supply. The outward appearance of the glass sheet with a terminal for a vehicle can be improved by using the terminal structure which has a high degree of freedom in its mounted position.

Preferably, the conductive member has a distal end part which comprises a sheet-shaped part. The object of power supply is connected to the conductive member via the sheet-shaped part. Since the sheet-shaped part covers the connecting portion between the object of power supply and the conductive member, the connecting portion is not outwardly visible. The outward appearance of the terminal structure is improved by keeping the connecting portion from being outwardly visible.

### BRIEF DESCRIPTION OF THE DRAWINGS

FIG. 1 is a front view showing a vehicular glass sheet equipped with a terminal according to the present invention;

FIG. 2 is an enlarged view of section 2 of FIG. 1, showing in front elevation the terminal structure according to a first embodiment of the present invention;

FIG. 3 is a cross-sectional view taken along line 3-3 of FIG. 2;

FIG. 4 is a front view showing a terminal structure according to a second embodiment;

FIG. 5A is a front view showing a terminal structure according to a third embodiment;

FIG. 5B is a front view showing the terminal structure wherein a terminal crimp part of FIG. 5A is attached to a side surface of the terminal part;

FIG. 5C is a front view showing the terminal structure wherein the terminal crimp part of FIG. 5A is attached to a connecting part of the terminal part;

FIG. 6 is a partial cross-sectional view showing a conventional terminal structure; and

FIG. 7 is a perspective view showing a separate conventional terminal structure.

### MODES FOR CARRYING OUT THE INVENTION

Certain preferred embodiments of the present invention will be described below with reference to the accompanying drawings.

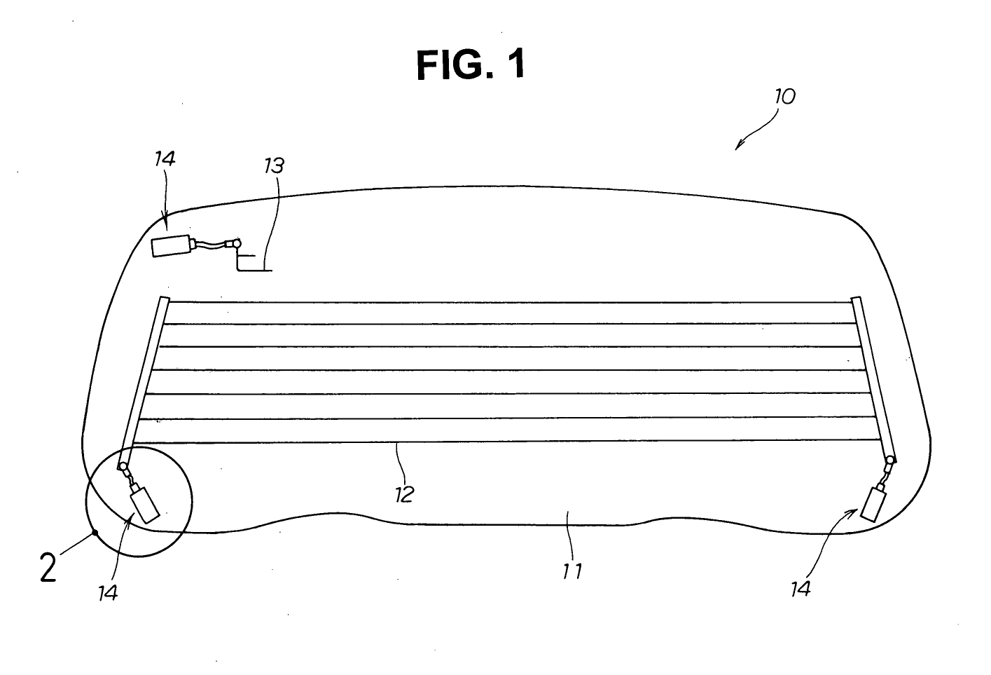

As shown in FIG. 1, a vehicular, terminal-equipped glass sheet 10 is formed by disposing, on a top surface of a glass sheet 11, power-supplied objects such as a heater 12 and an antenna 13, and electrically connected terminal structures 14, details of which will be described later.

When the power-supplied object 12 is a heater, the heater 12 is connected through the terminal structures 14 to a power source (not shown) for operating the heater 12. When the power-supplied object 13 is an antenna, the antenna 13 is connected through the terminal structures 14 to a television (not shown) mounted inside the vehicle.

Possible examples of external devices connected to the power-supplied objects, aside from a power source and a television, include an AM radio, an FM radio, a car navigation system, an electronic toll collection system (ETC) and the like. That is, the type of the external devices does not matter here as long as those devices are connected to the power-supplied objects.

Similarly, the power-supplied objects should not be construed as being limited to heaters and antennas and may include others which are connected through the terminal structures 14.

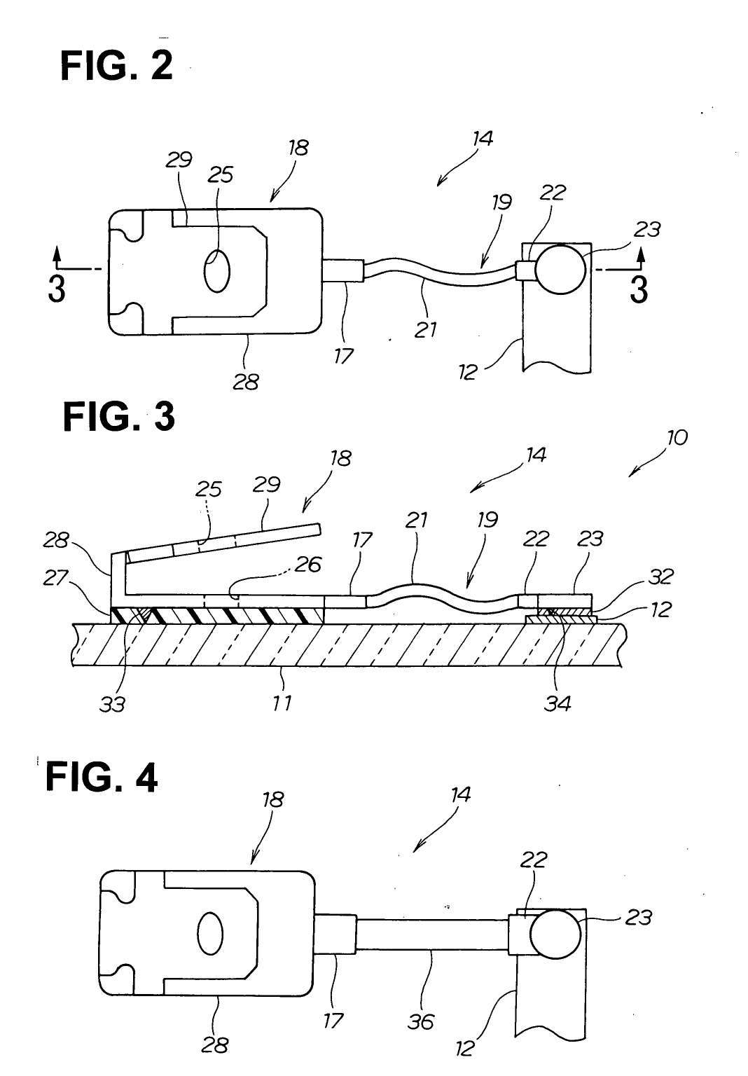

Next, one of the terminal structures will be described with reference to FIGS. 2 and 3. As shown in the Figures, the terminal structure 14 comprises a terminal part 18 and a conductive member 19. The terminal part 18 is comprised of a base part 28 affixed to the glass sheet 11, a connecting part 29 to be connected to the external device, and a terminal crimp part 17 attached to an end part of the base part 28. One end of the conductive member 19 is electrically connected to the terminal crimp part 17, and an opposite end extends to the power-supplied object 12.

The base part 28 is L-shaped. The base part 28 is attached to the top surface of the glass sheet 11 by an adhesive 27. The base part 28 and the connecting part 29 have respective holes 25, 26.

The conductive member 19 is comprised of a lead wire 21 crimped at one end to the terminal crimp part 17, a conductor crimp part 22 to which an opposite end of the lead wire 21 is crimped, and a sheet-shaped part 23 in the form of a disc for supporting the conductor crimp part 22.

The sheet-shaped part 23 comprises a distal end of the conductive member 19. The power-supplied object 12 is connected to the conductive member 19 via the sheet-shaped part 23. Since the connecting portion of the sheet-shaped part 23 between the power-supplied object 12 and the conductive member 19 is covered, the connecting portion is not exposed to the exterior. Thus, the terminal structure has a satisfactory outward appearance.

Besides crimping, welding or any other desired method of connecting the lead wire 21 may be employed as long it achieves electrical connection.

The sheet-shaped part 23, which is the distal end part of the conductive member 19, is bonded to the power-supplied object 12 using solder or a conductive adhesive. Specifically, the sheet-shaped part 23 of the conductive member 19 is electrically connected to the power-supplied object 12 via a conductive bonding part 32 composed of solder, a conductive adhesive, or the like, as shown in FIG. 3. Protruding members 33, 34 make the height of the adhesive 27 or the conductive bonding part 32 uniform. In other words, after the terminal part 18 is positioned to a desired position on the glass sheet 11 by the protruding members 33, 34, the adhesive 27 is poured through the holes 25, 26 of the terminal part 18 into a space formed between the glass sheet 11 and a bottom surface of the base part 28. With the adhesive 27 of a predetermined height, the terminal part 18 is caused to adhere to the top surface of the glass sheet 11. Therefore, the terminal part 18 can be attached in a simple manner to a freely selected location on the glass sheet 11.

Lead-free solder is preferably used as the conductive bonding part 32. Since the lead-free solder does not contain lead, using lead-free solder as the conductive bonding part 32 makes it possible to provide an environmentally friendly terminal structure 14 or a vehicular, terminal-equipped glass sheet 10.

The terminal part 18 and the power-supplied object 12 are connected by the flexible conductive member 19. Since the conductive member 19 is flexible, the conductive member 19 can be mounted without interfering with other components or the like. Additionally, the conductive member 19 can have any desired length. Specifically, the conductive member 19 can be freely mounted at any position set apart from the power-supplied object 12 toward the terminal part 18. The terminal structure can be regarded to have a high degree of freedom in its mounted position.

Additionally, the distal end of the conductive member 19 is connected to the power-supplied object 12 using solder, a conductive adhesive, or another conductive bonding part 32. The solder or the conductive adhesive has excellent conductivity. Since the solder or the conductive adhesive has excellent conductivity, satisfactory conductivity can be maintained in the device connected to the power-supplied object 12 and the terminal structure 14.

Referring next to FIG. 4, discussion will be made as to the terminal structure according to the second embodiment of the present invention. The same reference numerals will be used to denote components common to the first embodiment shown in FIG. 2, and their detailed description will be omitted.

In the terminal structure according to the second embodiment, a flexible, thin metal plate 36 is disposed instead of the lead wire 21 of the first embodiment shown in FIG. 3, the metal plate being covered on obverse and reverse surfaces thereof by an insulating film.

Even in cases in which such a structure is used, the terminal structure 14 can be freely mounted at a position distanced from the object 12 of power supply. The terminal structure can be regarded to have a high degree of freedom in its mounted position.

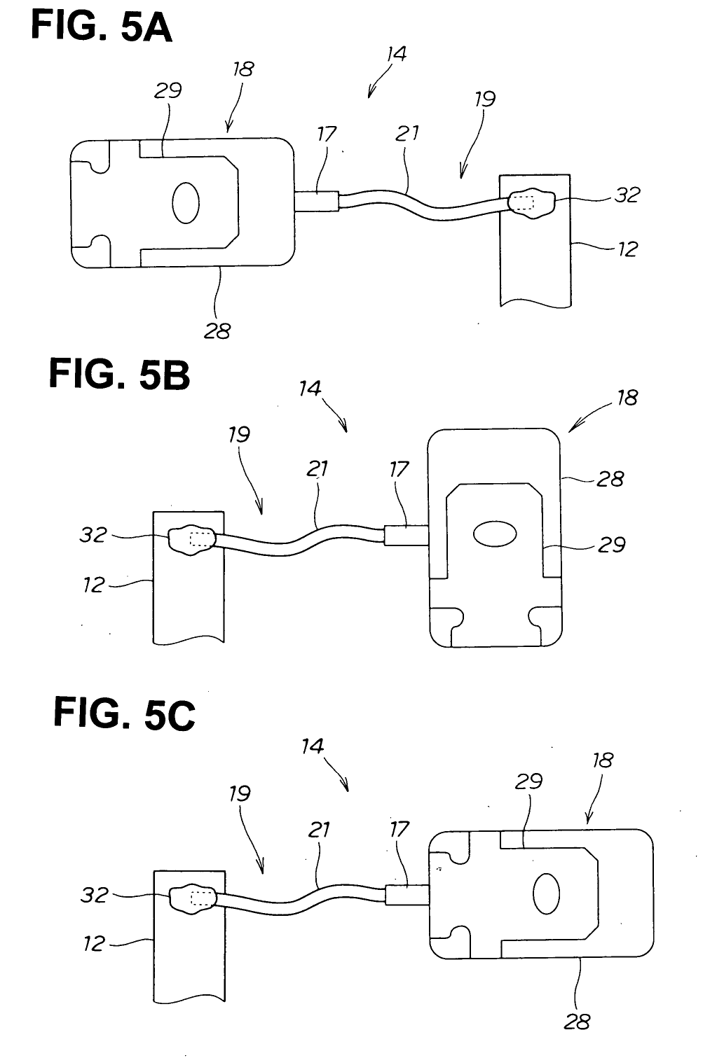

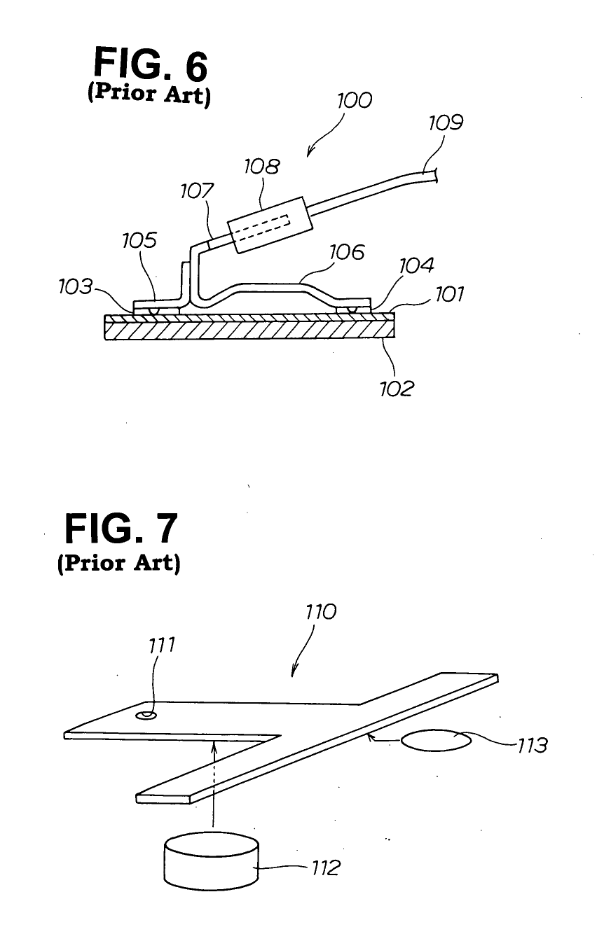

Next, the terminal structure according to the third embodiment of the present invention will be described with reference to FIG. 5A. Herein, the same reference numerals will be used to denote components common to the first embodiment shown in FIG. 2, and those components will not be described in detail. In the third embodiment shown in FIG. 5A, the lead wire 21 and the conductive bonding part 32 are directly bonded to the power-supplied object 12. Specifically, in this structure, the sheet-shaped part 23 (FIG. 2) is not used.

Even in cases in which such a structure is used, the terminal structure 14 can be freely mounted at a position distanced from the power-supplied object 12. The terminal structure can be regarded to have a high degree of freedom in its mounted position.

Furthermore, the effects of the present invention can be sufficiently achieved even if the terminal crimp part 17 is mounted on the side surface of the terminal part 18 as shown in FIG. 5B, or the terminal crimp part 17 is mounted on the side of the terminal part 18 having the connecting part 29 as shown in FIG. 5C. Specifically, the terminal crimp part 17 can be mounted at any desired location on the terminal part 18.

When the terminal structure according to the present invention is used, mounting the terminal part 18 and the flexible conductive member 19 apart from each other makes it possible to reduce the load acting on the conductive member 19 from the exterior when an external device is connected to the terminal part 18. By reducing the load from the exterior, the conductive member 19 can be reduced in size, and the amount of conductive adhesive or solder used in the conductive bonding part 32 can be reduced, which is beneficial.

In the described embodiments, examples have been presented in which the terminal structure according to the present invention is applied to a vehicular, terminal-equipped glass sheet; however, the terminal structure can also be used in security window glass for a building, defogging glass for a refrigerating showcase, or in any other desired application.

### INDUSTRIAL APPLICABILITY

The terminal structure of the present invention is suitable for a vehicular, terminal-equipped glass sheet, but can also be applied to security window glass for a building or defogging glass for a refrigerating showcase.

### LEGEND

10 . . . vehicular, terminal-equipped glass sheet; 11 . . . glass sheet; 12, 13 . . . power-supplied objects; 14 . . . terminal structure; 18 . . . terminal part; 19 . . . conductive member; 23 . . . sheet-shaped part; 32 . . . conductive bonding part

1. A terminal structure comprising:
a terminal part capable of being affixed to a glass sheet by an adhesive; and
a conductive member extending from the terminal part to a power-supplied object and having flexibility.

2. The terminal structure of claim 1, wherein the conductive member has a distal end part, and the distal end part is a sheet-shaped part.

3. (canceled)

4. A vehicular, terminal-equipped glass sheet comprising:
a glass sheet for a vehicle;
a terminal part affixed to the glass sheet by an adhesive; and
a conductive member extending from the terminal part to a power-supplied object and having flexibility.

5. The vehicular, terminal-equipped glass sheet of claim 4, wherein the conductive member has a distal end part, and the distal end part is a sheet-shaped part.
